(19) United States
(12) Patent Application Publication
(10) Pub. No.: US 2014/0108445 A1
(43) Pub. Date: Apr. 17, 2014

(54) System and Method for Personalizing Query Suggestions Based on User Interest Profile

(71) Applicant: Google Inc., (US)

(72) Inventor: Bilgehan Uygar Oztekin, Mountain View, CA (US)

(73) Assignee: Google Inc., Mountain View, CA (US)

(21) Appl. No.: 13/860,496

(22) Filed: Apr. 10, 2013

Related U.S. Application Data
(63) Continuation of application No. 13/102,931, filed on May 6, 2011, now abandoned.
(60) Provisional application No. 61/483,009, filed on May 5, 2011.

(51) Int. Cl. G06F 17/30

(52) U.S. Cl. CPC G06F 17/3097; G06F 17/30864
USPC 707/767

(57) ABSTRACT

A server system receives a partial search query from a search requestor prior to the search requestor signaling completion of a search query that includes the partial search query. The server system responds to receipt of the partial search query by obtaining a set of complete queries previously submitted by a community of users. The complete queries correspond to the partial query and are ordered in accordance with ranking criteria. The server system sends the set of ordered complete queries to the search requestor. The server system obtains the set of complete queries by generating scores for a plurality of the obtained complete queries previously submitted by the community of users in accordance with an interest profile of the search requestor and ordering the obtained complete queries in accordance with the generated scores and the ranking criteria.

### RELATED APPLICATION

This application claims priority to U.S. Provisional Application Ser. No. 61/483,009, filed May 5, 2011, entitled “System and Method for Personalizing Query Suggestions Based on User Interest Profile,” which is incorporated herein by reference in its entirety.

### TECHNICAL FIELD

The present invention relates generally to the field of search engines for locating documents in a computer network, and in particular, to a system and method for increasing a user's search efficiency by using the user's interest profile to anticipate the user's request based on a partially entered search query.

### BACKGROUND

Search engines provide a powerful tool for locating documents in a large database of documents, such as the documents on the World Wide Web (WWW) or the documents stored on the computers of an Intranet. The documents are located in response to a search query submitted by a user. A search query may consist of one or more search terms. Some search engines incorporate the known interests of the user in evaluating search results returned to the user.

In one approach to entering queries, the user enters the query by adding successive search terms until all search terms are entered. Once the user signals that all of the search terms of the query have been entered, the query is sent to the search engine. The user may have alternative ways of signaling completion of the query by, for example, entering a return character, by pressing the enter key on a keyboard or by clicking on a “search” button on a graphical user interface. Once the query is received by the search engine, it processes the search query, searches for documents responsive to the search query, and returns a list of documents to the user.

Query suggestions may be provided to the user prior to the user signaling that the query is complete. It would be desirable to have a system and method for improving the query suggestions provided to the user.

### SUMMARY OF DISCLOSED EMBODIMENTS

According to some embodiments, a server system receives a partial search query from a search requestor. The server system receives the partial search query prior to the search requestor signaling completion of a search query that includes the partial search query. The server system responds to receipt of the partial search query by obtaining a set of complete queries previously submitted by a community of users. The complete queries correspond to the partial query and are ordered in accordance with ranking criteria. The server system sends the set of ordered complete queries to the search requestor. The server system obtains the set of complete queries by generating scores for a plurality of the obtained complete queries previously submitted by the community of users in accordance with an interest profile of the search requestor and ordering the obtained complete queries in accordance with the generated scores and the ranking criteria.

According to some embodiments, a client system sends a partial search query from the client system to a server system, which is distinct from the client system. The client system sends the partial search query from the client system prior to the client system signaling completion of a search query that includes the partial search query. The client system receives from the server system, in response to the partial query, a set of ordered complete queries, ordered in accordance with an interest profile of the search requestor.

### BRIEF DESCRIPTION OF THE DRAWINGS

FIG. 1 is a block diagram of a distributed client-server computing system including an information server system, according to some embodiments.

FIG. 2 is a block diagram of an exemplary server system in accordance with some embodiments.

FIG. 3A is a block diagram of a data structure used by a query log database to store historical query information for a set of users in accordance with some embodiments.

FIG. 3B is a block diagram of a data structure used by a query profile database to store query profile information for a set of queries in accordance with some embodiments.

FIG. 3C is a block diagram of a data structure used by a user profile database to store information for a set of user profiles in accordance with some embodiments.

FIG. 3D is a block diagram of an information classification database for storing URL profiles for a set of URLs in accordance with some embodiments.

FIG. 4 is a flow diagram illustrating an exemplary process for building the user profile database in accordance with some embodiments.

FIG. 5 depicts the process of handling a partial search query and displaying predicted queries in accordance with some embodiments.

FIG. 6 depicts an exemplary user interface in accordance with some embodiments.

FIG. 7 is a block diagram of an exemplary client device in accordance with some embodiments.

FIG. 8 depicts a process performed by a client device, for example by a client assistant of the client device, in accordance with some embodiments.

FIG. 9 is a flow diagram illustrating a method performed by a client device for obtaining an ordered list of complete queries based on a submitted partial query and the interest profile of a search requestor, in accordance with some embodiments.

FIG. 10 is a block diagram illustrating an exemplary process for processing a partial query and ordering the corresponding predicted complete queries, and optionally query results, in accordance with some embodiments.

FIG. 11A-11E are flow diagrams illustrating an exemplary process for personalizing query suggestions provided to a search requestor, in accordance with some embodiments.

Like reference numerals refer to corresponding parts throughout the drawings.

### DESCRIPTION OF EMBODIMENTS

Reference will now be made in detail to embodiments, examples of which are illustrated in the accompanying drawings. While particular embodiments are described, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present invention. First ranking criteria and second ranking criteria are both ranking criteria, but they are not the same ranking criteria.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

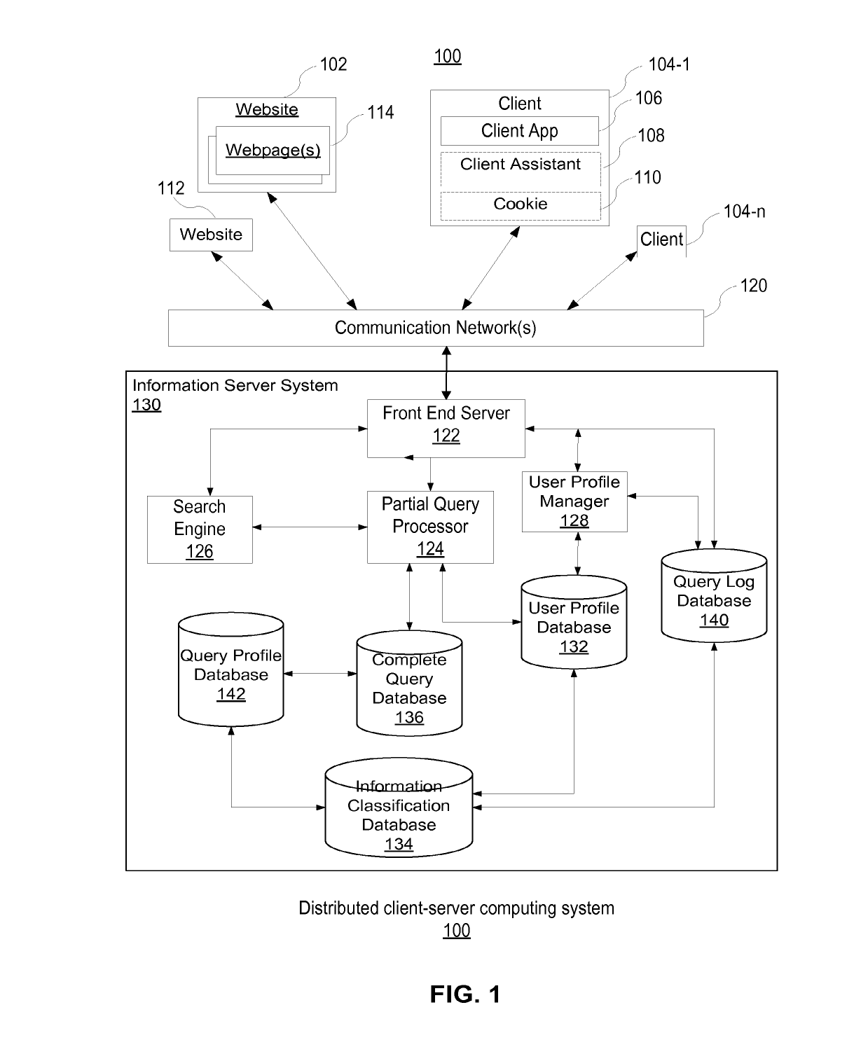

FIG. 1 is a block diagram of a distributed client-server computing system 100 including an information server system 130. Information server system 130 is connected to a plurality of clients 104 and websites 102 through one or more communication networks 120.

A website 102 may include a collection of web pages 114 associated with a domain name on the Internet. Each website (or web page) has a content location identifier, for example a universal resource locator (URL), which uniquely identifies the location of the website on the Internet.

The client 104 (sometimes called a “client system,” or “client device” or “client computer”) may be any computer or similar device through which a user of client 104 can submit service requests to and receive search results or other services from information server system 130. Examples include, without limitation, desktop computers, laptop computers, tablet computers, mobile devices such as mobile phones or smart phones, personal digital assistants, set-top boxes, or any combination of the above. A respective client 104 may contain at least one client application 106 for submitting requests to the information server system 130. For example, client application 106 can be a web browser or other type of application that permits a user to search for, browse, and/or use information (e.g., web pages and web services) at website 102. In some embodiments, client 104 includes one or more client assistants 108. Client assistant 108 can be a software application that, when executed by one or more processors of client 104, performs one or more tasks related to assisting a user's activities with respect to client application 106 and/or other applications. For example, client assistant 108 may assist a user at client 104 with browsing information (e.g., files) hosted by a website 102, processing information (e.g., search results) received from information server system 130, and monitoring the user's activities on the search results. In some embodiments the client assistant 108 is embedded in one or more web pages (e.g., a search results web page) or other documents downloaded from information server system 130. In some embodiments, the client assistant 108 is a part of the client application 106 (e.g., a plug-in of a web browser). In some embodiments, the client 104 includes one or more cookies 110.

Communication network(s) 120 can be any wired or wireless local area network (LAN) and/or wide area network (WAN), such as an intranet, an extranet, the Internet, or a combination of such networks. In some embodiments, communication network 120 uses the HyperText Transport Protocol (HTTP) and the Transmission Control Protocol/Internet Protocol (TCP/IP) to transport information between different networks. The HTTP permits client devices to access various information items available on the Internet via communication network 120. The various embodiments, however, are not limited to the use of any particular protocol. The term “information item” as used throughout this specification refers to any piece of information or service that is accessible via a content location identifier (e.g., a URL or URI) and can be, for example, a web page, a website including multiple web pages, a document, a video/audio stream, a database, a computational object, a search engine, or other online information service.

In some embodiments, information server system 130 includes a front end server 122, a partial query processor 124, a search engine 126, a profile manager 128, a complete query database 136, a query log database 140, a query profile database 142, a user profile database 132, and optionally an information classification database 134, or a subset of these components. Information server system 130 receives partial queries from clients 104, processes the partial queries to produce an ordered set of complete queries, and returns the ordered set of complete queries to requesting clients 104. The ordered set of complete queries for a respective partial query are processed, based at least in part on the query profile information from query profile database 142 and a interest profile of the query requestor obtained from the user profile database 132, to produce an ordered set of complete queries whose order has been determined in accordance with the interest profile of the search requestor. The ordered set of complete queries is sometimes herein called a primary set of complete queries, which are set to the user as suggested complete search queries. Furthermore, the suggested complete queries sent to the user optionally include supplemental complete queries, as described further below.

Front end server 122 is configured to receive a partial query from a client 104. The partial query is processed by partial query processor 124 to produce a set of ordered complete queries. Partial query processor 124 is configured to obtain a set of complete queries associated with the received partial query from complete query database 136. Partial query processor 124 is also configured to use data stored in query profile database 142 and user profile information stored in user profile database 132 to determine the order of the set of complete queries sent to the search requestor. At least a subset of the ordered complete queries is sent to client 104 as suggested search queries.

Optionally, after the list of complete queries has been ordered, the complete search query at the top of the ordered list (e.g., a highest ranked complete query in the obtained set of complete queries) is sent to search engine 126. Search engine 126 then generates a group of provisional search results based on the top complete query and front end server 122 sends the provisional search results to the client 104-1 for display. Optionally, the provisional search results are concurrently displayed with the suggested search queries.

In accordance with some embodiments, after receiving the suggested complete search queries from information server system 130, client 104 displays or otherwise presents the suggested complete search queries to a user. In some embodiments, client assistant 108 monitors the user's activities on the suggested complete search queries, on any provisional search results, and on any search results returned to client 104 after submission of a complete query, and generates corresponding query log data. The query log data includes one or more of the following: identification of a complete search query selected by the user, user selection(s) of one or more of the search results (also known as “click data”), selection duration (amount of time between user selection of a URL link in the search results and user exiting from the search results document or selecting another URL link in the search results), and pointer activity with respect to the search results.

In some embodiments, the query log data is sent by client 104 to the information server system 130 and stored, along with impression data, in query log database 140. Impression data for a historical search query optionally includes one or more scores, such as an information retrieval score, for each listed search result, and position data indicating the order of the search results for the search query, or equivalently, the position of each search result in the set of search results for the search query.

The user profile database 132 stores a plurality of user profiles, each user profile corresponding to a respective user. In some embodiments, a respective user profile includes multiple sub-profiles, each classifying a respective aspect of the user in accordance with predefined criteria. User profile database 132 is accessible to at least partial query processor 124 and query log database 140.

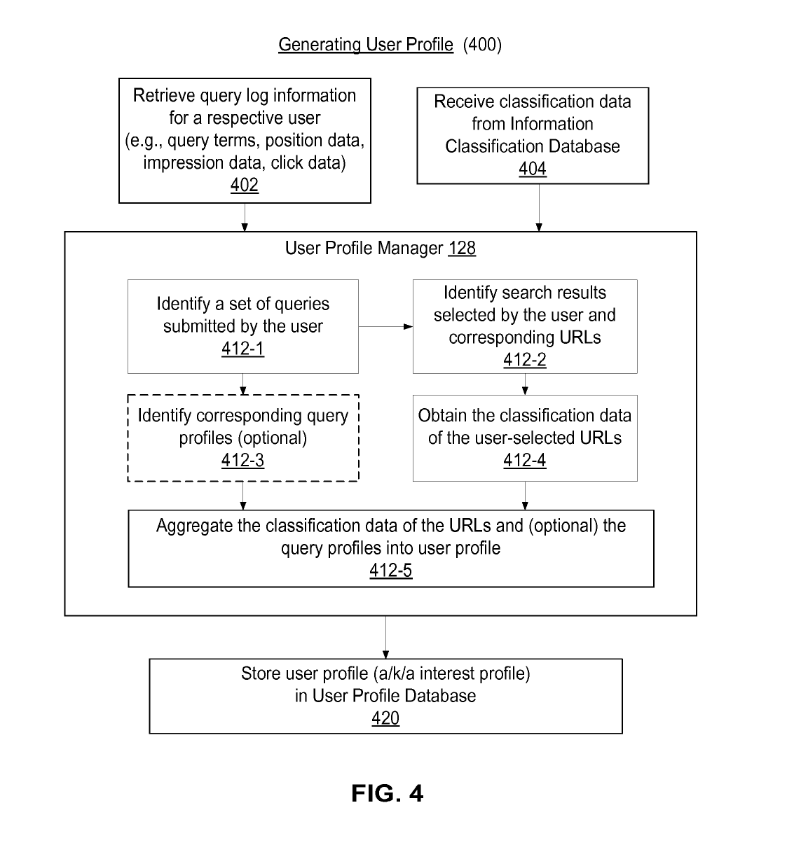

User profile manager 128 creates and maintains at least some user profiles for users of information server system 130. As described in more detail below with reference to FIG. 4, user profile manager 128 uses the user's search history stored in query log database 140 to determine a user's search interests. Optionally, historical records of other online activities of a respective user are used to determine the user's interests, and to supplement the user's search interests as determined from query log database 140.

The information classification database 134 stores classification data for a set of information items. In some embodiments, classification data in the information classification database 134 is used when generating or updating query profiles and user profiles.

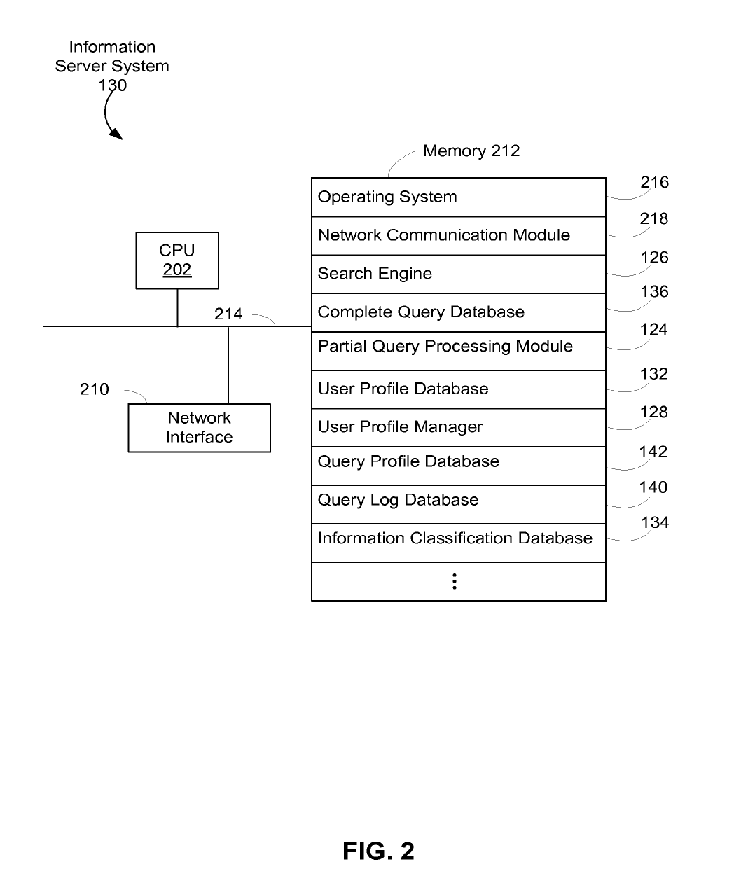

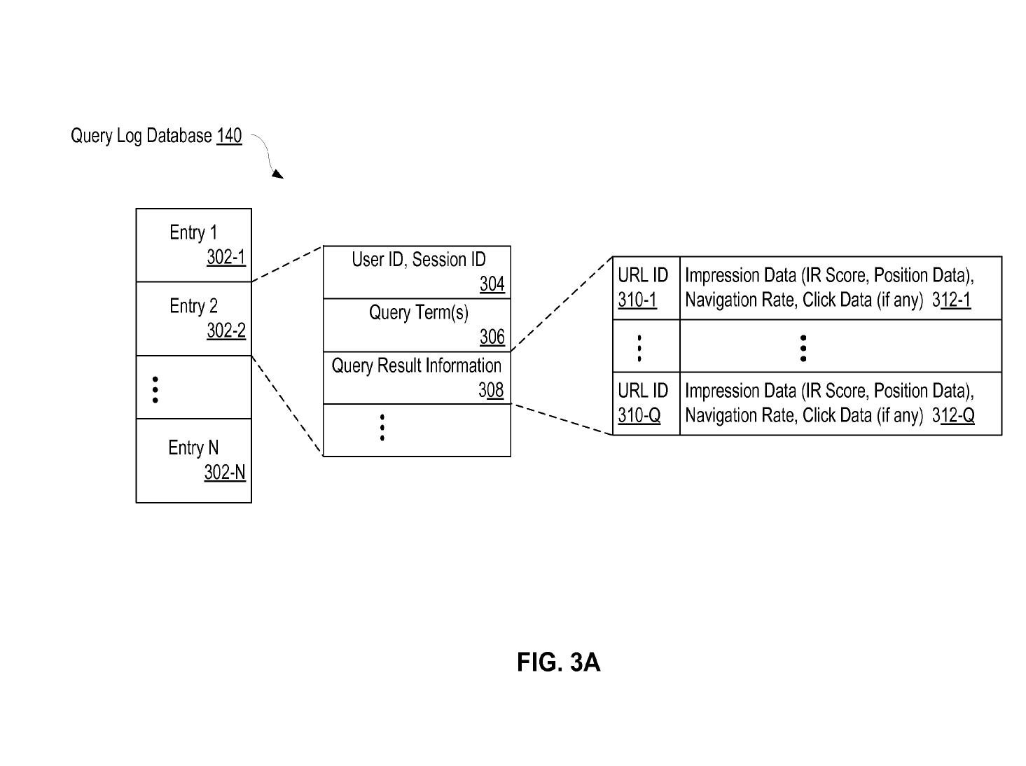

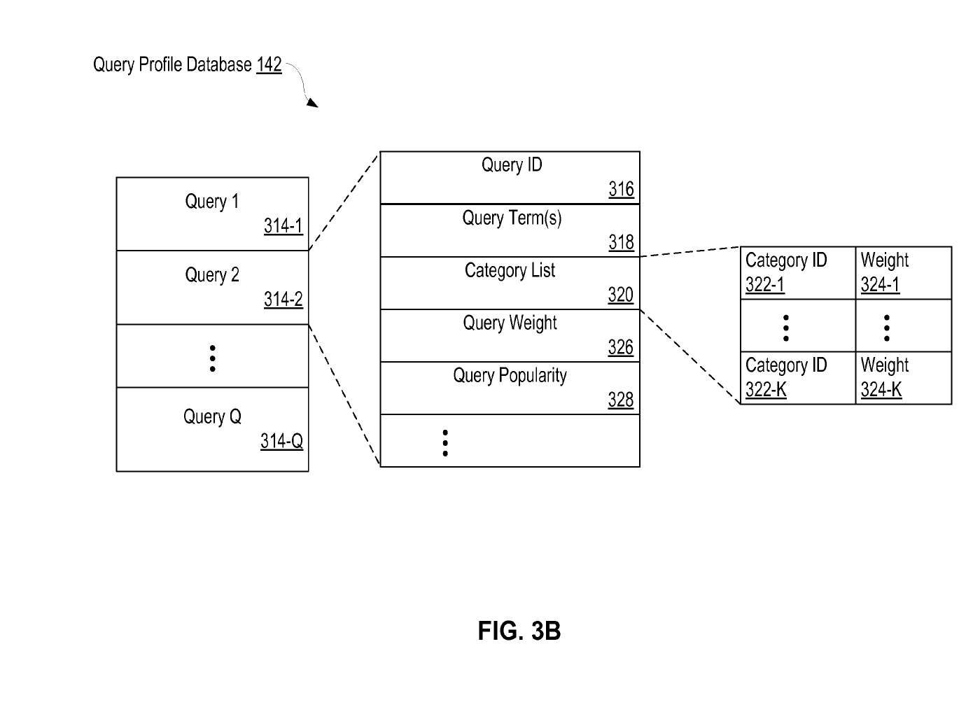

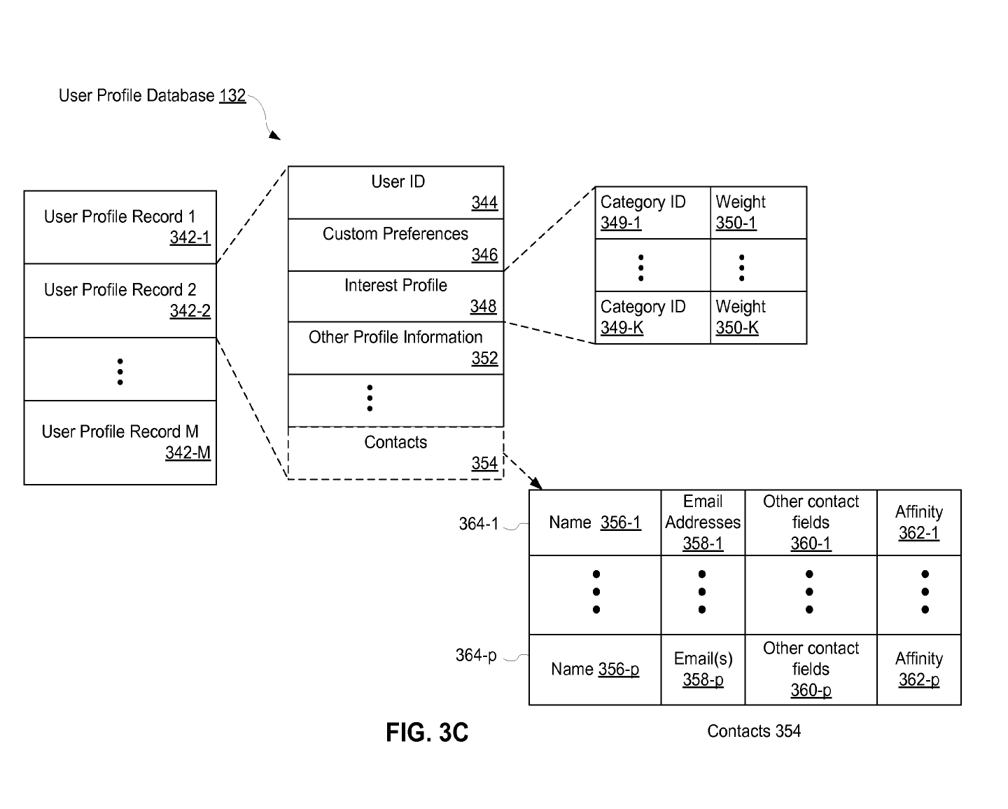

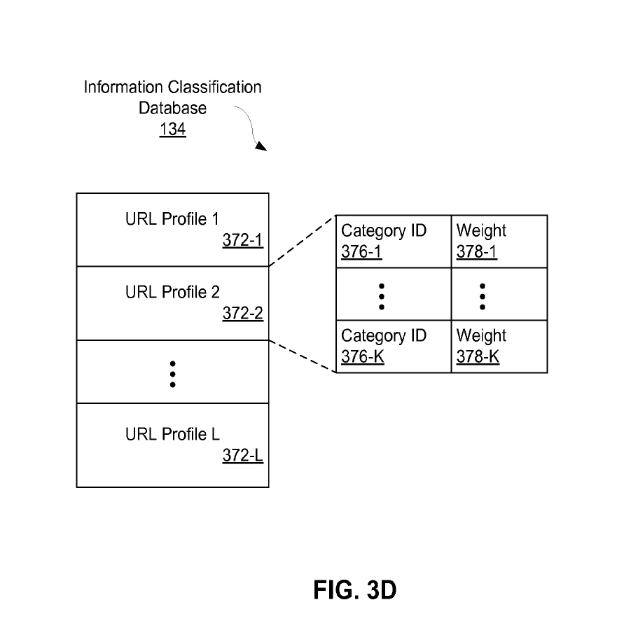

FIG. 2 is a block diagram illustrating an information server system 130 in accordance with some embodiments. Information server system 130 generally includes one or more processing units (CPU's) 202, one or more network or other communications interfaces 210, memory 212, and one or more communication buses 214 for interconnecting these components. Information server system 130 optionally includes a user interface comprising a display device and a keyboard; more typically, information server system 130 is controlled from one or more client devices or systems (not shown). Memory 212 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately the non-volatile memory device(s) within memory 212, comprises a non-transitory computer readable storage medium. Memory 212 or the computer readable storage medium of memory 212 stores the following elements, or a subset of these elements, and may also include additional elements:
an operating system 216 that includes procedures for handling various basic system services and for performing hardware dependent tasks;
a network communication module 218 that is used for connecting information server system 130 to other computers via the one or more communication network interfaces 210 (wired or wireless) and one or more communication networks, such as the Internet, other wide area networks, local area networks, metropolitan area networks, and so on;
search engine 126 for processing queries;
complete query database 136 for storing and retrieving complete queries;
partial query processor 124 for retrieving a set of complete queries in accordance with a received partial query;
user profile database 132 for storing user profile information;
user profile manager 128 for building and maintaining user profiles;
query log database 140 for storing historical query information, described below with reference to FIG. 3A;
query profile database 142 for storing classification profiles of user-submitted complete queries, described below with reference to FIG. 3B; and
optionally, information classification database 134 for storing classification data for various information items.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. For example, some of the modules and/or databases shown in FIG. 2 may be encompassed within partial query processor 124. In some embodiments, memory 212 may store a subset of the modules and data structures identified above. Furthermore, memory 212 may store additional modules and data structures not described above.

FIG. 2 is intended more as a functional description of the various features of an information server system rather than a structural schematic of the embodiments described herein. In practice, and as recognized by those of ordinary skill in the art, items shown separately could be combined and some items could be separated. For example, some items shown separately in FIG. 2 could be implemented on single servers and single items could be implemented by one or more servers. For example, search engine 126 may be implemented on a different set of servers than the other components of information server system 130. The actual number of servers used to implement information server system 130, and how features are allocated among them will vary from one implementation to another, and may depend in part on the amount of data traffic that the system must handle during peak usage periods as well as during average usage periods.

FIG. 3A illustrates a block diagram for an exemplary query log database 140 for storing historical query information in accordance with some embodiments. Query log database 140 includes a plurality of query records 302-1-302-N, each corresponding to a query submitted by a respective user at a respective time from a respective location. Query log database 140 is maintained by information server system 130 or by another system (not shown) that makes query log database 140 accessible to information server system 130. In some embodiments, a respective query record 302 of query log database 140 includes one or more of the following: user ID (identifying the user who submitted the query corresponding to the record 302) and session ID 304; query terms 306 of the query; and query result information 308 that includes a plurality of URL IDs (e.g., 310-1 . . . 310-Q) representing the search results for the query, and additional information (312-1 . . . 312-Q) for the URL IDs in the search results. In some embodiments, query record 302 for a respective query only stores information for the top Q (e.g., 40 or 50) search results, even though the query may generate a much larger number of search results.

In some embodiments, the additional information for a respective URL ID in query result information 308 includes impression data (e.g., the IR (information retrieval) score of the URL, which is a measure of the relevance of the URL to the query, and the position of the URL in the search results); the navigation rate of the URL (the ratio between user selections of the URL and user selections of all the URLs in the search results for the same query during a particular time period, such as the week or month preceding submission of the query); and click data indicating whether the URL has been selected by a user among all the URLs. Note that the navigation rate of a URL indicates its popularity with respect to the other URLs among users who have submitted the same query. Optionally, the additional information associated with a URL identifies information items that contain the URL, such as other web pages, images, videos, books, etc. In some embodiments, a query record 302 also includes geographical and demographical information of a query, such as the country/region from which the query was submitted and the language of the query. For example, for the same set of query terms submitted from different countries or at different times, the search results may be different. As will be explained below, the information in query log database 140 can be used to generate accurate classification data for large numbers of URLs.

In some implementations, user ID 304 is a unique identifier for identifying the user (sometimes, the client) that submits the query. In many embodiments, to protect privacy of the system's users, user ID 304 uniquely identifies a user or client, but cannot be used to identify the user's name or other identifying information. The same applies to user ID 344 of user profile record 342 discussed below with respect to FIG. 3C. In some embodiments, a network communication session is established between client 104 and information server system 130 when the user first logs into the information server system or re-logs into the system after a previous session expires. In either case, a unique session ID 304 is created for the session and it becomes part of the query record 302. In some implementations, each term of the query terms 306 in a respective record 302 comprises a term originally submitted by the user (in the query corresponding to a respective record 302) or a canonical version of the term adopted by the server system.

At client 104, query results corresponding to a submitted complete query (or corresponding to a highest ranked complete query suggested in accordance with a partial query) are received and displayed. Received search results are ordered and are typically divided into pages or other groups; search results that are actually displayed by client 104 are sometimes called impressions. Client assistant 108 monitors the user's activities on the displayed search results for a respective query. In some embodiments, the information produced by the monitoring includes the search results displayed to the user (called impressions), the amount of time the user spends on different search results (e.g., by tracking the position of the user's cursor over the search results), and the search results selected by the user for viewing. This user interaction information and other data characterizing usage of the search results is sent back to information server system 130 (or whatever system maintains query log database 140) and stored in a respective record 302 of query log database 140.

Optionally, record 302 for a respective query further includes other information, such as location information (e.g., city, state, country or region) for the search requestor and the language of the query. The queries for which information is stored in the query log database 140 are queries from a community of users, such as all users of the corresponding search engine 126. In some embodiments, the system includes multiple query log databases, or the query log database 140 is partitioned, with each query log database or partition storing records corresponding to queries received from a respective community of users, such as all users submitting queries in a particular language (e.g., English, Japanese, Chinese, French, German, etc.), all users submitting queries from a particular country or other jurisdiction or from a certain range of IP addresses, any suitable combination of such criteria.

FIG. 3B depicts a block diagram of an exemplary query profile database 142 for storing query profiles in accordance with some embodiments. Similar to query log database structure 140 in FIG. 3A, query profile database 142 includes a plurality of query profile records 314-1 to 314-P, sometimes herein called query profiles, each of which corresponds to a user-submitted query. When the same query is submitted by many users, a single query profile 314 stores profile information for the query. In some embodiments, each query profile 314 contains a query ID 316 that identifies a particular query, the set of corresponding query terms 318 in the query, and a category list 320 for classifying the query. Optionally, the query profile 314 may be assigned an overall query weight 326. Optionally, query weight 326 corresponds to a degree of confidence in the classification of the query by the category list 320.

Optionally, the query profile 314 includes query popularity 328, the query popularity comprising a numeric value corresponding to how often users in a respective community of users have submitted the query corresponding to query profile 314. In some other embodiments, query popularity values are stored in complete query database 136 for respective complete queries.

In some embodiments, the category list 320 for a respective query entry 314 includes one or more category/weight pairs (category ID 322, weight 324), and typically includes a plurality of category/weight pairs. In some implementations, the category identified by category ID 322 corresponds to a particular category of information, concept, topic, or information class or subclass type in a defined or predefined taxonomy, herein called a category for convenience, and weight 324 is typically a numeric value (e.g., a value between 0 and 1 or a value in a predefined range) representing relevance of the category to the query. In one example, the category list 320 for the query “golf” has relatively high weights for a plurality of categories associated with sports and sporting goods, but low weights for categories associated with information technology (IT). In some implementations, the number of categories in any one category list 320 is limited to a predefined maximum number (e.g., 5, 10 or 20 categories) even if the taxonomy in which the categories are defined has thousands of distinct categories.

In some embodiments, query profile database 142 includes a respective query profile 314 for each complete query in complete query database 136. In some other embodiments, query profile database 142 includes a respective query profile 314 for a subset of the complete queries in complete query database 136. In the latter embodiments, when the query profile database 412 does not have a query profile for a respective query, the query may be classified using a classifier. For example, the text of the query may be classified to produce a query profile. Alternatively, or in addition, the top N search results (e.g., highest ranked search results) (e.g., the top 3, 5 or 10; and more generally, N is typically 20 or less, and more typically is 10 or less) for the respective query are identified, profiles for those search results are obtained from the information classification database 134 (FIG. 3D) or other source, and those profiles are combined (e.g., weighted in accordance with the rankings of the search results and then combined) to produce either the query profile or to produce a portion of the information used to generate the query profile.

FIG. 3C is a block diagram of a user profile database 132 for storing user profiles 342 for a set of users in accordance with some embodiments. User profile database 132 includes a plurality of user profile records 342-1 to 342-P, sometimes herein called user profiles, each of which corresponds to a particular user of information server system 130. In some embodiments, a respective user profile 342 includes a user ID 344, an interest profile 348 that includes one or more category/weight pairs (category ID 349, weight 350) representing interests of the user, and, optionally, a list of contacts 354. In some embodiments, the interests of the user are derived from search activity of the user (e.g., search queries and selections of search results), and optionally derived from additional sources of information about the user such other online activities of the user (e.g., text and/or correspondence the user has authored (e.g., web pages, blogs, documents, email, chats, online posts), web sites the user has visited), social network information for the user, and self-entered information. It is noted that the user may be required to opt in or accept one or more invitations to various online services in order to have such information included in the user's user profile 342. In some implementations, the user profiles 342 contain no personally identifiable information (e.g., user name, mailing address, telephone, contacts) that can be traced back to the respective users, so as to protect the privacy of the users. Alternatively, in some implementations such information is included in the only the user profiles of users who have explicitly agreed to the collection or inclusion of such information. In some implementations, any personally identifiable information in the user profile of a respective user can be removed from the user profile upon request by the user.

Optionally, the user profile record 342 includes one or more custom preferences 346 (e.g., favorite topics, preferred ordering of search results), which may be manually specified by the user (e.g., using a web form configured for this purpose). In addition, the user profile record 342 may optionally include other types of user profile information, such as geographic locations, product identifiers, the user's name, other entity names, dates and times, labels, social network information, etc. that can be extracted, inferred or otherwise known from the user's search history or other sources of information about the user.

In some embodiments, the classification data, and in particular the weights 350, of different user's interest profiles 348 are normalized such that, for the same category that appears in the interest profiles of different users, their respective weights are comparable. Thus, when a first user's interest profile has a higher weight for a respective category than a second user's interest profile, this indicates a higher level of interest by the first user in the respective category than the second user.

Optionally, contacts 354 include contact entries 364-1 through 364-p, where p represents the number of entries in contacts 354 of the user. A respective contact entry (e.g., entry 364-p) includes a field for storing name information (e.g., first name, last name) of the respective contact 356-p, an affinity value 362-p for the respective contact, and optionally one or more of: email address(es) 358-p and other contact fields 360-p.

In some embodiments, the contacts 354 include entries 364 that correspond to users that the user has added to the user's contacts (e.g., an address book of the user). In some embodiments, contacts 354 also include entries that are generated automatically without human intervention. For example, in some embodiments the automatically generated entries correspond to users who have communicated with the respective user, and satisfy predefined criteria (e.g., frequency of communication, or at least one reply communication from the user to the contact).

Affinity value 362 represents an importance and/or frequency of communication with the respective contact. In some implementations, affinity value 362 is set by the user (e.g., by adding the respective contact to a particular group, such as “family,” or by manually indicating that the respective contact is important). In some embodiments, affinity value 362 is determined by a computer system without human intervention based on, for example, the frequency of communication between the user and the respective contact.

FIG. 3D is a block diagram of an information classification database 134 for storing URL profiles 372 (also herein called document profiles) for a set of URLs in accordance with some embodiments. Information classification database 134 includes a plurality of URL profiles 372-1 to 372-L, each of which corresponds to a particular information item available on a communication network 120 (FIG. 1). In some embodiments, a respective URL profile 372 includes one or more category/weight pairs (category ID 376, weight 378) representing categories related to the URL (i.e., categories related to the document or information item corresponding to the URL). In some implementations, the category identified by category ID 376 corresponds to a particular category of information, concept, topic, or information class or subclass type in a defined or predefined taxonomy, herein called a category for convenience, and weight 378 is typically a numeric value (e.g., a value between 0 and 1 or a value in a predefined range) representing relevance of the category to the URL (i.e., to the document or information item corresponding to the URL).

In some embodiments, the weights 378, of different URL profiles 372 are normalized such that, for the same category 376 that appears in the URL profiles of different URLs, their respective weights 378 are comparable. Thus, when a first URL profile has a higher weight for a respective category than a second URL profile, this indicates a higher level of correlation between the first URL and the respective category than between the second URL and the respective category.

FIG. 4 is a flow diagram illustrating an exemplary process 400 for generating an interest profile 348 (see FIG. 3C) for a respective user. This process uses historical query information in query log database 140 (FIGS. 1 and 3A) for the user, and classification data stored in information classification database 134 (FIGS. 1 and 3D).

In accordance with some implementations, to build a user interest profile for a respective user, user profile manager 128 retrieves 402 query log information, also called historical query information, for the respective user from query log database 140. From the retrieved historical query information, user profile manager 128 identifies 412-1 a set of queries submitted by a respective user, identifies 412-2 search results selected by the user and the URLs corresponding to the selected search results. For one or more of the identified URLs corresponding to the selected search results, user profile manager 128 obtains 412-4 classification data, also called the URL profile (362, FIG. 3D).

Optionally, user profile manager 128 also identifies query profiles in the query profile database 142 for the queries submitted by the respective user, and obtains the classification data from those query profiles for at least a subset of the identifier query profiles. As noted above, query classification data for one or more of the queries submitted by the respective user is alternatively obtained using a classifier instead of the query profile database 142. In one example, classification data is obtained for queries submitted by the user in at least N distinct query sessions, during the last M days, where N and M are predefined values.

User profile manager 128 aggregates 412-5 the classification data of the user-selected search result URLs, and optionally the classification data from the query profiles as well, into an interest profile 348 (FIG. 3C) for the respective user. Optionally, the user profile manager 128 also aggregates other sources of classification data when producing the interest profile 348 for the respective user; such other sources of classification data including the user's one or more of bookmarks (e.g., bookmarks of the user recorded using a particular browser application, or bookmarks of the user recorded using a respective bookmark synchronization application, and/or bookmarks of the user recorded at a server) selected by the user, toolbar visits by the user, items the user has recommended to others via a social network, and other online actions performed by the user during the session. In some embodiments, the interest profile of a search requestor is time weighted, with greater weight given to recent events, recent events comprising events that occurred within a predefined number of time units of the current time, than to less recent events. As noted above, the weights in the aggregated classification data is optionally normalized, so that the weights in the interest profiles of different users have comparable significance. The generated interest 348 profile is stored in the user profile database 420 as part of the user profile 342 (FIG. 3C) of the respective user.

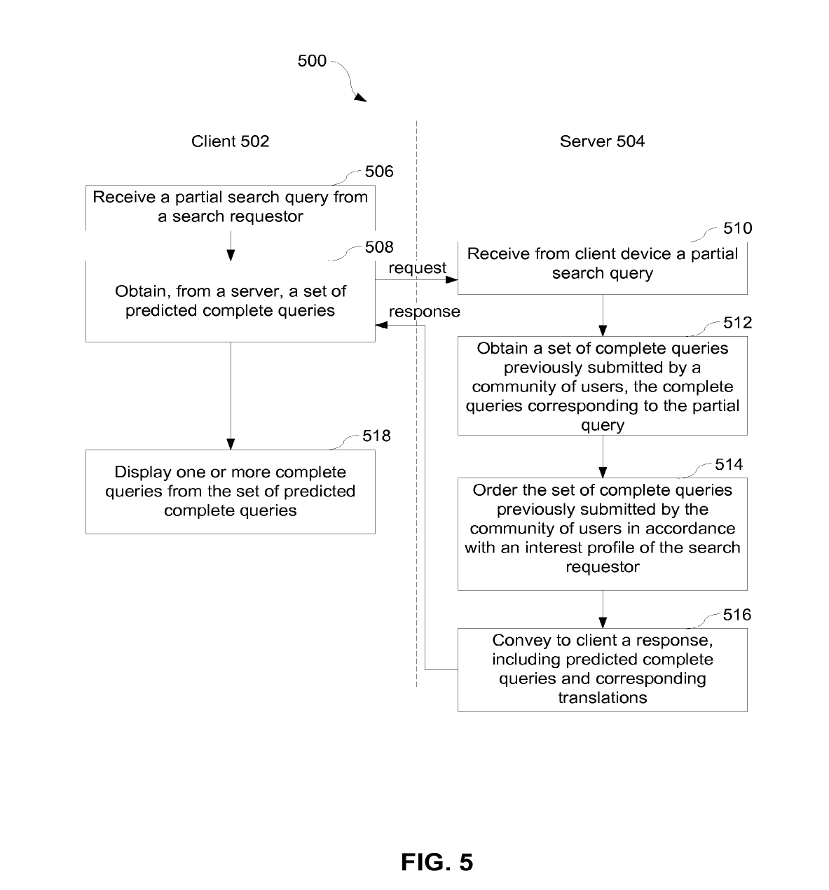

FIG. 5 depicts a process 500 of processing a partial search query and obtaining an ordered set of complete queries, in accordance with some embodiments. Process 500 is performed in part by a respective client device 502 and in part by a server system 504. In some implementations the process depicted in FIG. 5 is performed by client 104 and information server system 130 as shown in FIG. 1. Client 502 receives 506 a partial search query from a user (also called a search requestor). The partial search query may be one or more characters, one or more words, or one or more words followed by one or more characters. Client 502 obtains 508 from a server 504 a set of predicted complete queries, also called suggested queries. Subsequently, client 502 displays 518 to the search requestor one or more of the set of ordered complete queries (suggested queries) received from server 504. In some embodiments, client 502 displays the entire set of ordered complete queries (suggested queries) as obtained from server 504.

In accordance with some implementations, server 504 receives 510 the partial search query from client 504. Server 504 then obtains 512, in accordance with the partial search query, a set of complete queries previously submitted by a community of users. In some embodiments, server 504 obtains 512 the set of complete queries associated with the partial search query from a complete query database 136. Server 504 orders 514 the set of complete queries previously submitted by a community of users in accordance with the interest profile of the search requestor, and conveys 516 to client 502 a response which includes at least a subset of the ordered set of complete queries (sometimes called the suggested queries or suggested complete queries). In some embodiments, server 504 limits the number of suggested complete queries sent to client 502 to a predefined maximum number (e.g., 5 to 10).

In some embodiments, the suggested complete queries include the partial query. However, in other embodiments, one or more of the suggested complete queries include or are based on mappings of the partial query and/or terms in the suggested complete queries that take into account synonyms, spelling corrections and variations, conceptual mappings, translations, historically highly correlated terms, and the like.

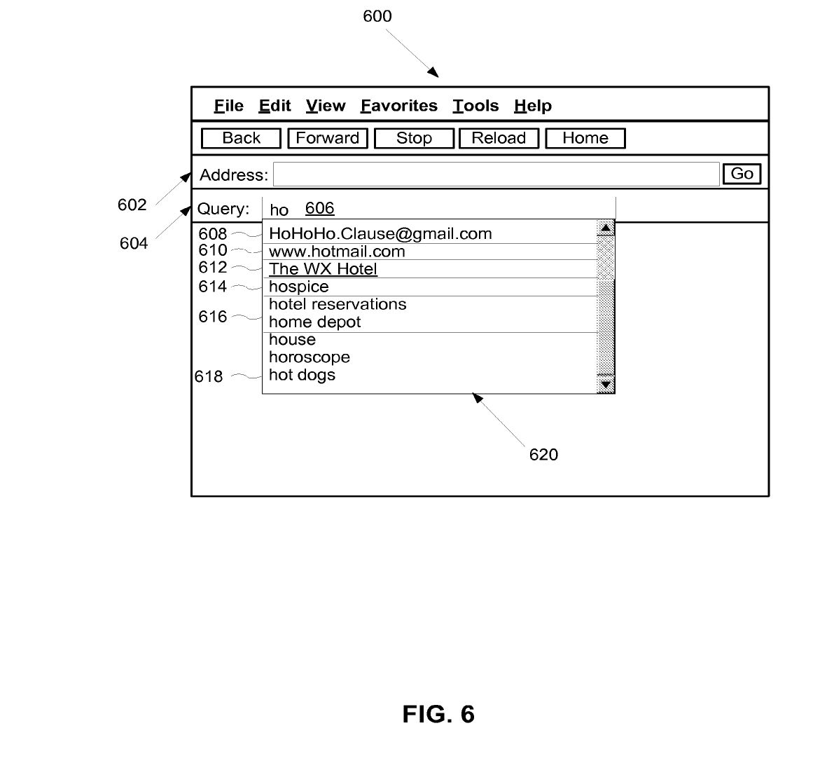

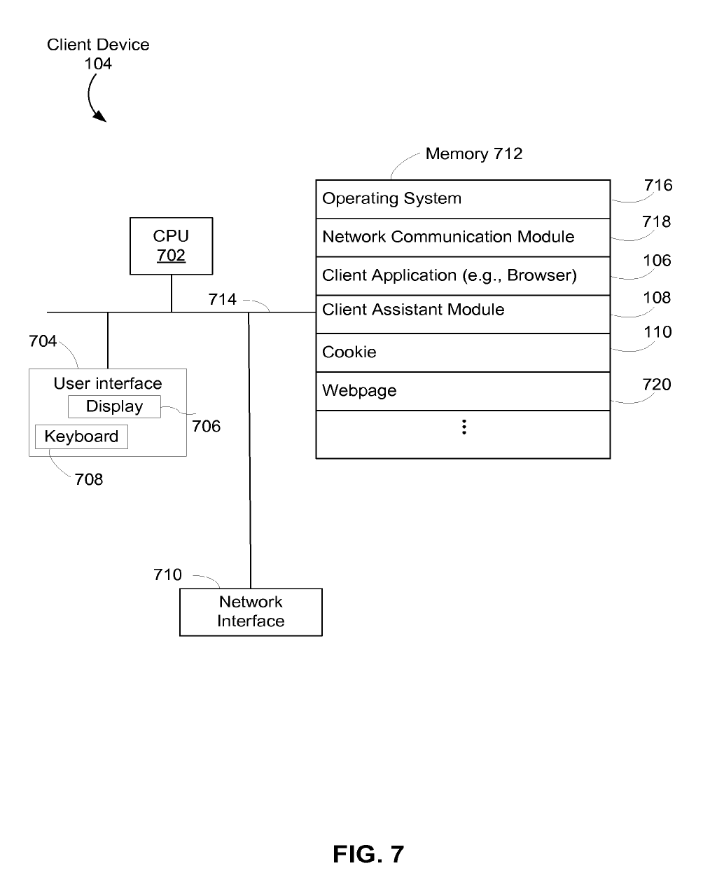

FIG. 6 illustrates an exemplary user interface 600 enabling a search requestor to enter a partial search query and receive a set of suggested complete queries, according to some implementations. In this example, user interface 600 comprises a browser window that includes a toolbar 602 including a text entry box 604. The example in FIG. 6 depicts a partial query <ho> in text entry box 604. Shortly after user entry of the partial query, the user interface displays a set of ordered complete queries (suggested queries) in display area 620 for selection by the user. As described elsewhere, the user interface 600 is displayed by a respective client 104 (see FIGS. 1 and 7), which sends the partial query to an information server system 130 (FIGS. 1 and 2), which responds by sending suggested complete queries to the respective client 104.

In some embodiments, user interface may also display, in addition to the set of ordered complete queries, additional suggestions associated with partial query. In accordance with some implementations, the additional suggestions include one or more of the following: one or more URLs 610 (represented here as the URL “www.hotmail.com”) associated with the partial query, complete queries 614 previously received from the search requestor which match the partial search query (represented here as the complete query “hospice”), one or more advertisements or links to advertisements 612 identified in accordance with the partial search (represented here a link having anchor text “The WX Hotel”), contact information 608 (e.g., an email address) for one or more persons having at least one contact field (e.g., name, email handle, domain name, address, company name, etc.) that matches or is otherwise consistent with the partial search query (represented here as the email address “HoHoHo.clause@gmail.com”), and supplemental complete queries 618, comprising complete queries previously submitted by a community of users, ordered in accordance with popularity within the community of users (represented here by the complete queries “house”, “horoscope”, “hot dogs”). In some embodiments, predefined criteria (e.g., a display space allocation scheme) is used to determine the number of each of these types of information to display as suggestions in accordance with the partial query.

FIG. 7 is a block diagram of a client device 104 (sometimes called a “client system,” or “client” or “client computer”) in accordance with some embodiments. Client device 104 generally includes one or more processing units (CPU's) 702, one or more network or other communications interfaces 710, memory 712, and one or more communication buses 714 for interconnecting these components. Communication buses 714 may include circuitry (sometimes called a chipset) that interconnects and controls communications between system components. In some embodiments, client device 104 includes a user interface 704. User interface 704 includes a display device 706 and optionally includes an input means such as a keyboard, mouse, a touch sensitive display, or other input buttons 708. Memory 712 includes high speed random access memory, such as DRAM, SRAM, DDR RAM or other random access solid state memory devices; and may also include non-volatile memory, such as one or more magnetic disk storage devices, optical disk storage devices, flash memory devices, or other non-volatile solid state storage devices. In some embodiments, memory 712 includes mass storage that is located remotely from the central processing unit(s) 702. Memory 712, or alternately the non-volatile memory device(s) within memory 712, comprises a non-transitory computer readable storage medium. Memory 712 or the computer readable storage medium of memory 712 stores the following elements, or a subset of these elements:
an operating system 716 that includes procedures for handling various basic system services and for performing hardware dependent tasks;
a network communication module 718 that is used for connecting the client 104 to other servers or computers via one or more communication networks (wired or wireless), such as the Internet, other wide area networks, local area networks, and metropolitan area networks and so on;
client application 106, such as a browser;
client assistant 108 (e.g., toolbar, browser plug-in, or executable instructions embedded in a web page), for monitoring the activities of a user;
optionally, a cookie 110 storing interest information of a search requestor; and
optionally, a webpage 720, such as a webpage displayed in a browser window as depicted in FIG. 6; the webpage optionally include a client assistant (not shown) for monitoring activities (e.g., text entered in a text entry box, and selections of suggested queries or other suggestions) of a user.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 712 may store a subset of the modules and data structures identified above. Furthermore, memory 712 may store additional modules and data structures not described above.

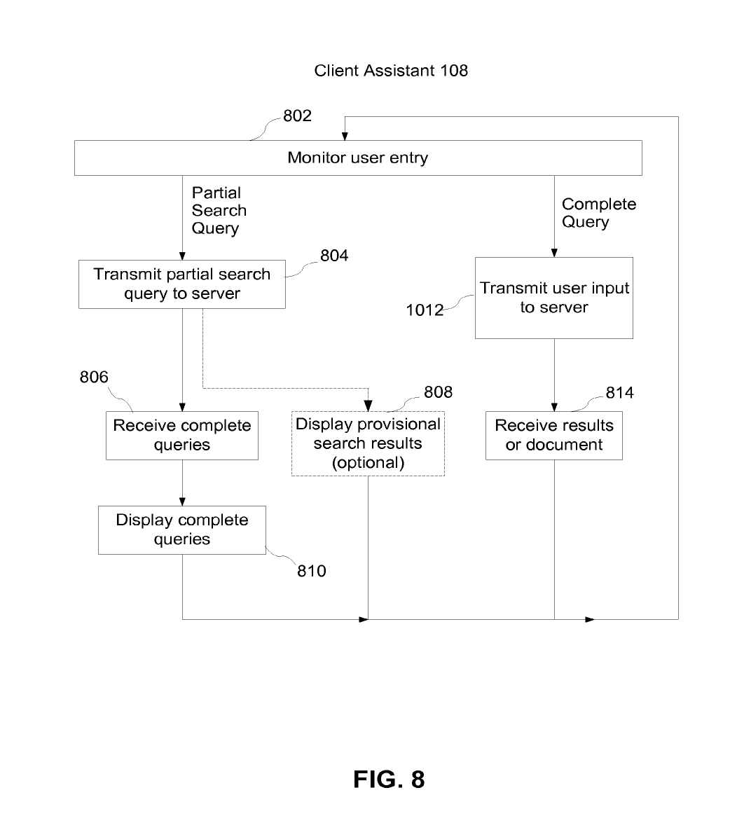

FIG. 8 illustrates an exemplary implementation of a client assistant 108 of a client device 104. In some embodiments, client assistant 108 performs the monitoring (802) and partial search query transmission (804) operations, while the other operations shown in FIG. 8 are performed by client application 106, such as a web browser.

Client assistant 108 monitors 802 user entry of a search query into a text entry box displayed by client device 104. See, for example, text entry box 606 of user interface 600 in FIG. 6. The user's entry may be one or more characters, one or more words, or one or more words followed by one or more characters.

In accordance with some implementations, client assistant 108 identifies two different types of queries. First, client assistant 108 identifies a partial search query when an entry is identified prior to the user indicating completion of the input string. Second, client assistant 108 identifies user input when the user selects a complete query from a set of suggested queries or indicates completion of the input string.

In some implementations, a partial search query may be identified prior to the user signaling a completed user input. For example, client assistant 108 identifies a partial search query by detecting entry or deletion of characters in a text entry box. Once a partial search query is identified, the partial search query is transmitted 804 to an information server system 130 (FIGS. 1 and 2). In response to the partial search query, the server returns an ordered set of complete queries (suggested queries) to client device 104. The client receives 806 the suggested complete queries and displays or otherwise presents 810 the suggested complete queries.

In accordance with some implementations, after the suggested queries are displayed 810 to the user, the user selects one of the suggested complete queries if the user determines that one of the suggestions matches the user's intended entry. In some implementations, the suggestions provide the user with additional information which had not been considered. For example, a user may have one query in mind as part of a search strategy, but seeing the suggested queries causes the user to alter the input strategy. Once the suggested complete queries are displayed 810, the user's input is again monitored. If the user selects one of the suggested complete queries, the user-selected query is transmitted 812 to the server as a complete query (also herein called a completed user input). After the request is transmitted, the user's input activities are again monitored 802.

In some embodiments, in addition to displaying suggested complete queries 810, client device 104 also displays 808 provisional search results from the server in accordance with the ordered set of complete queries. The displayed provisional search results are used to improve the efficiency of the search requestor. For example, if the search requestor user enters <hot>, the client displays an ordered list of complete queries that includes the suggested complete query <hotels> and also displays provisional search results for <hotels>. If the search requestor was interested <hotels>, the search requestor can select from the displayed provisional results without taking the time to complete the query.

When a user input or selection is identified as a complete query (also called a completed user input), client assistant transmits 812 the complete query to server 130 for processing. Server 130 returns a set of search results, which are received 814 by client device 104 (e.g., by client application 106, such as a browser application). In some implementations, client application 106 displays the search results at least as part of a web page. In some other embodiments, client assistant 108 displays the search results. Alternately, the transmission of a completed user input 812 and the receipt 814 of search results may be performed by a mechanism other than client assistant 108. For example, these operations may be performed by client application 106 using standard request and response protocols.

In accordance with some implementations client assistant 108 identifies a completed user input in a number of ways, such as when the user enters a carriage return, or equivalent character, selects a “find” or “search” button in a graphical user interface (GUI) presented to the user during entry of the search query, or by selecting one of a set of suggested queries presented to the user during entry of the search query. One of ordinary skill in the art will recognize a number of ways to signal the final entry of the search query.

After receiving 814 the results or document (e.g., a webpage with search results) for a complete query, or after displaying 810 the suggested complete queries and optionally displaying 808 provisional search results, the client assistant 108 continues to monitor 802 user entries until the user terminates the client application 106 and/or client assistant 108, for example by closing a web page that contains the client assistant 108.

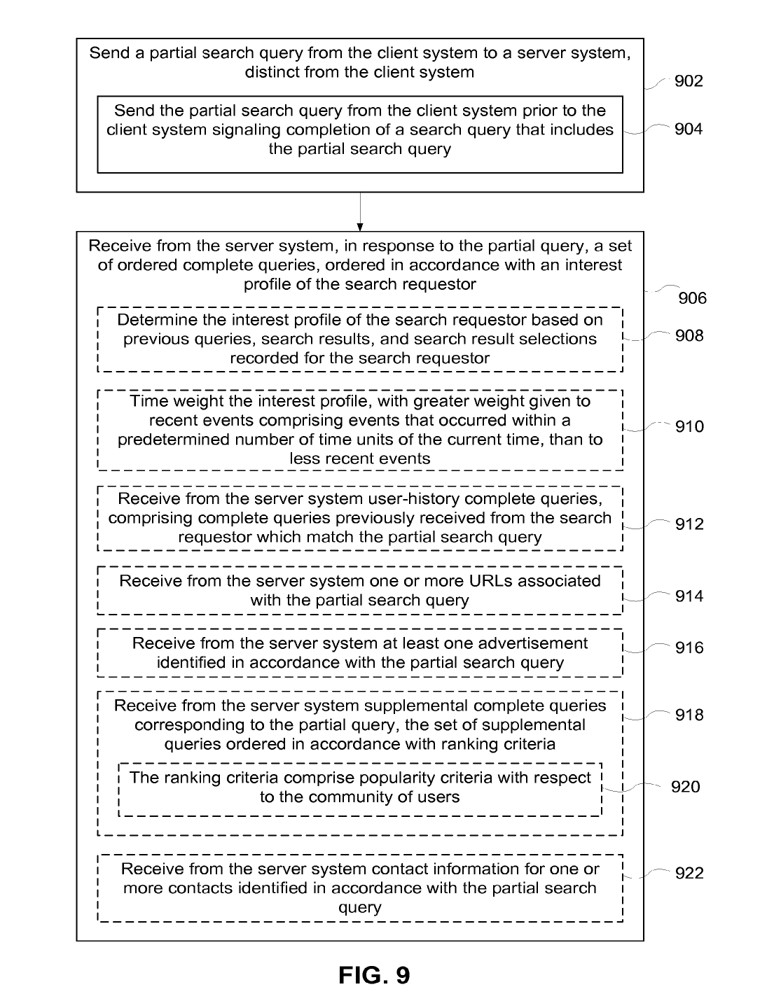

FIG. 9 depicts is a flow diagram illustrating a method performed by a client device for obtaining an ordered list of complete queries based on a submitted partial query and the interest profile of a search requestor, in accordance with some implementations. Optional operations are indicated by dashed lines (e.g., boxes with dashed-line borders).

In accordance with some implementations, a partial search query is sent 902 from client system 104 (FIG. 1) to a server system 130 (FIG. 1), distinct from the client system 104. The partial search query is sent 904 by the client system 104 prior to the client system 104 signaling completion of a search query that includes the partial search query.

In accordance with some implementations, a set of ordered complete queries, ordered in accordance with an interest profile 348 (FIG. 3C) of the search requestor, is received 906 from the server system 130, in response to the partial query. In some embodiments the interest profile 348 is determined 908 based on previous queries, search results, and search result selections recorded for the search requestor. In accordance with some implementations, interest profile 348 is time weighted 910, with greater weight given to recent events comprising events that occurred within a predetermined number of time units of the current time, than to less recent events.

In accordance with some implementations, client system 104 receives, in addition to the set of ordered complete queries, additional information that corresponds to the partial search query. For example, in some implementations, user-history complete queries which match the partial search query are also received 912 from server system 130, the user-history complete queries comprising complete queries previously received from the search requestor. In some implementations, one or more a URL's associated with the partial search query is are received 914 from server system 130. In some implementations, at least one advertisement identified in accordance with the partial search query is received 916 from server system 130.

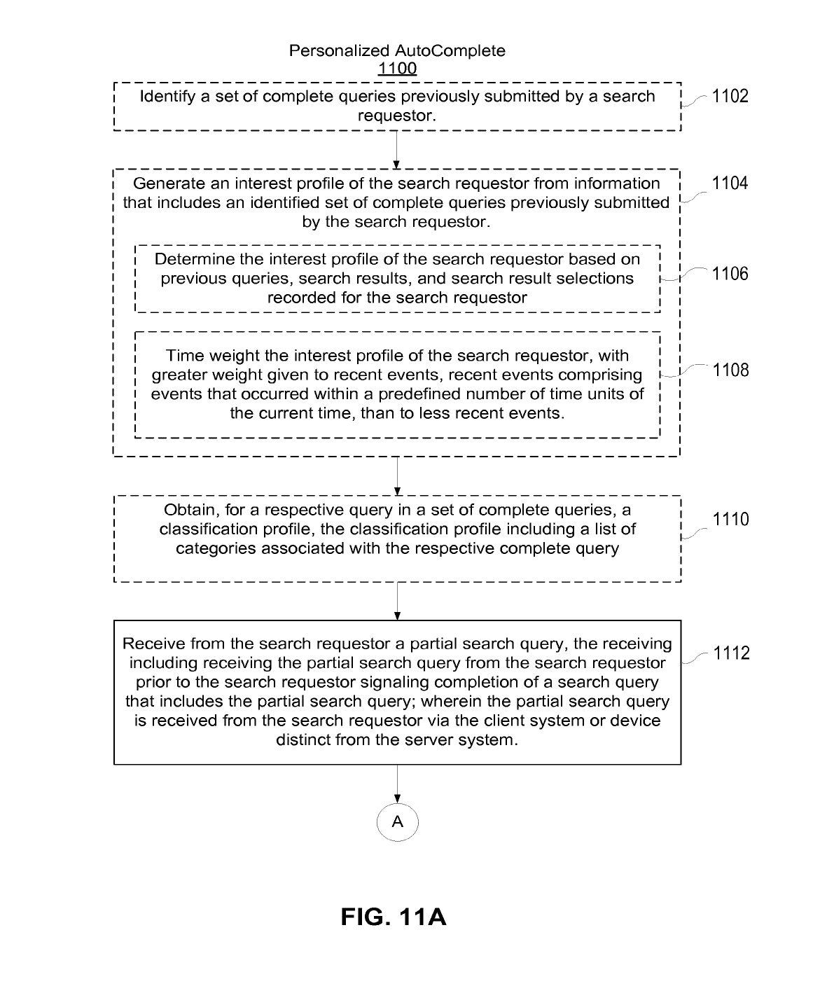

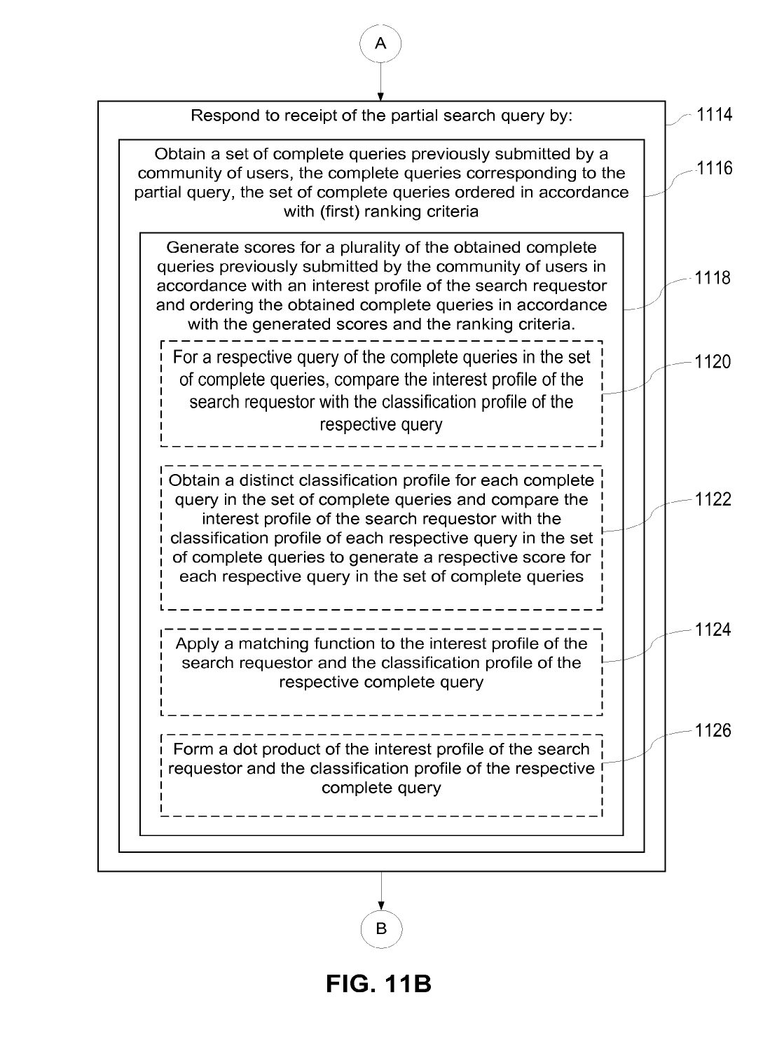

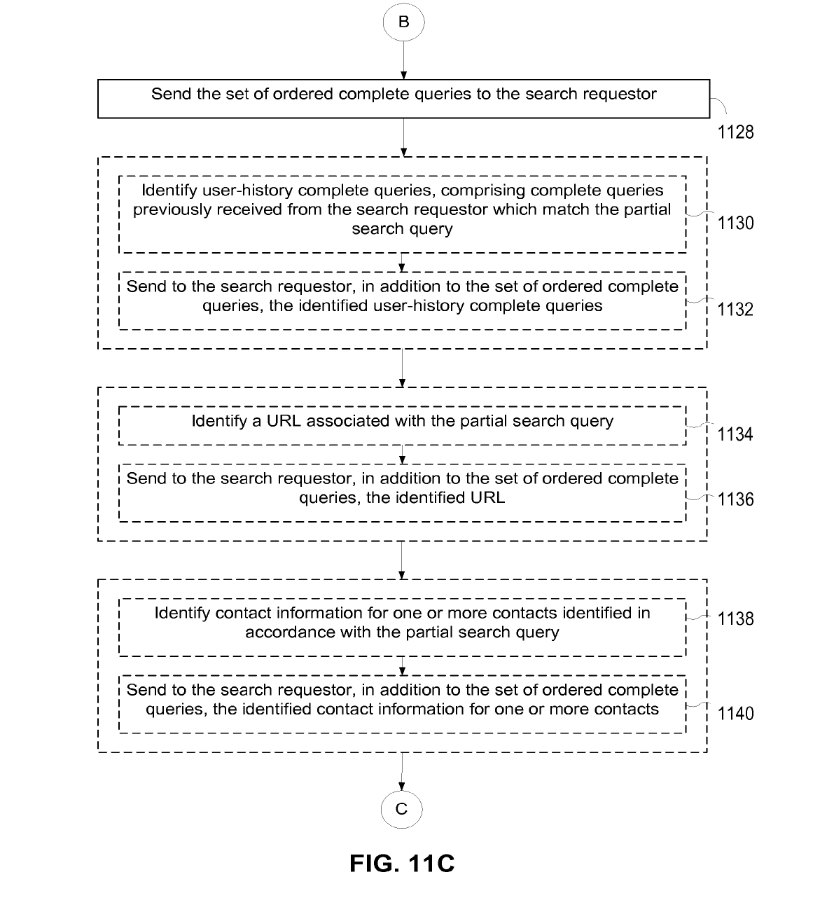

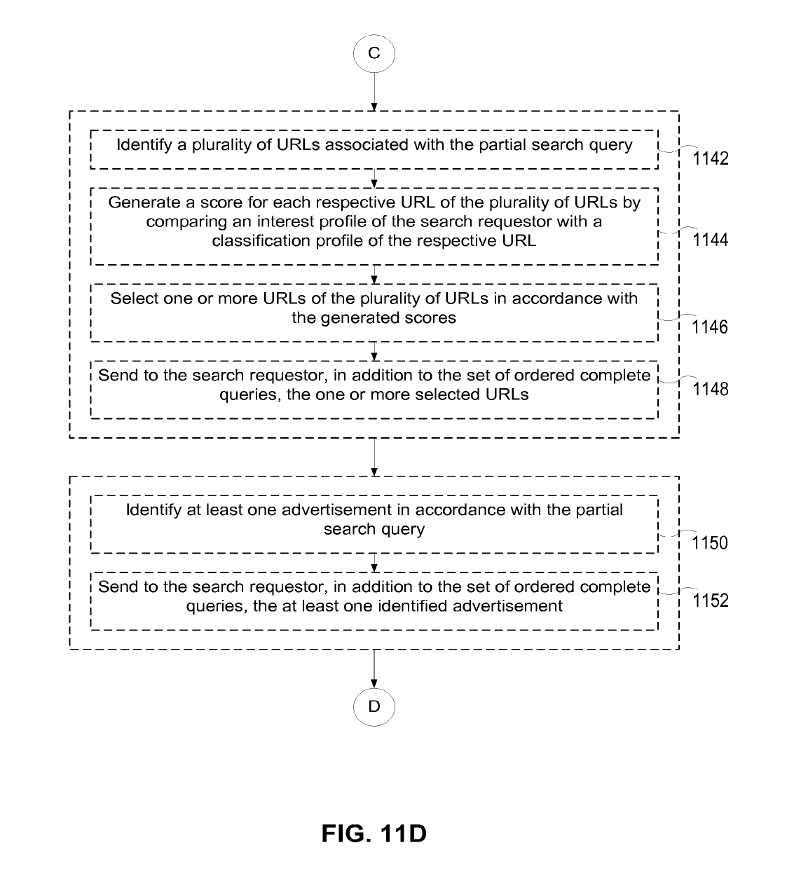

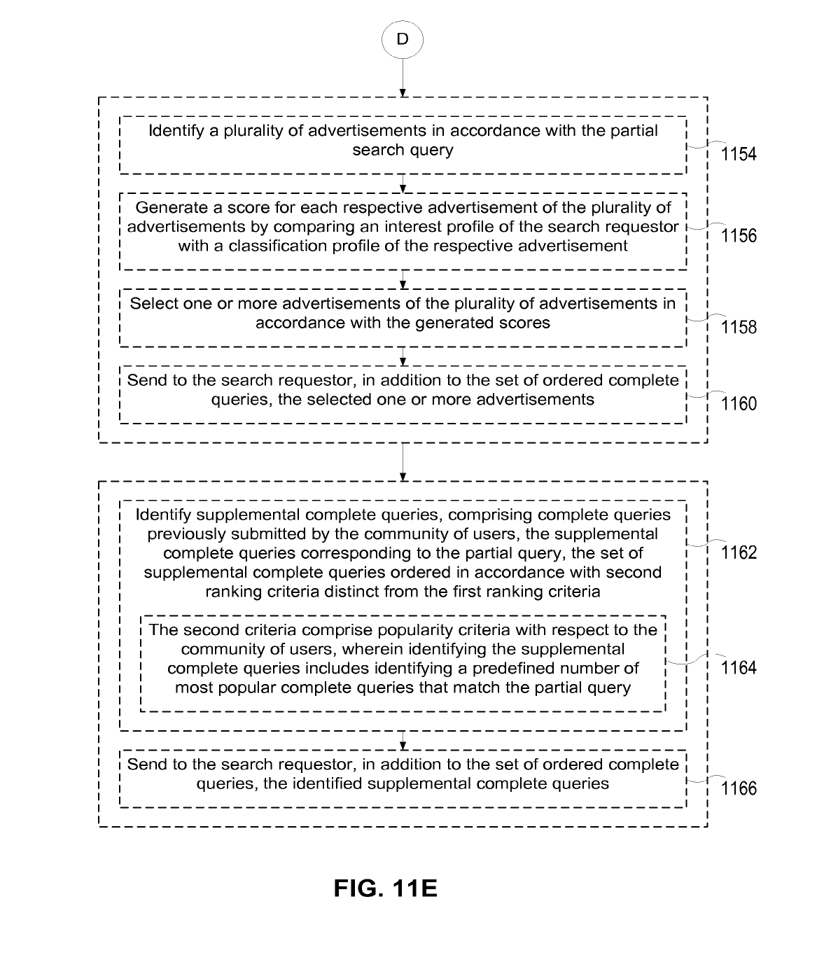

As noted above, the ordered set of complete queries is sometimes herein called a primary set of complete queries, which are sent to the user as suggested complete search queries. The suggested complete queries received by client system 104 from server system 130 optionally include supplemental complete queries corresponding to the partial query, the set of supplemental queries ordered in accordance with ranking criteria 918. In accordance with some embodiments, the ranking criteria comprise 920 popularity criteria with respect to a community of users. Popularity criteria are described below with reference to FIG. 11E. Furthermore, in accordance with some implementations, contact information for one or more contacts identified in accordance with the partial search query is received 922 from the server system 130.

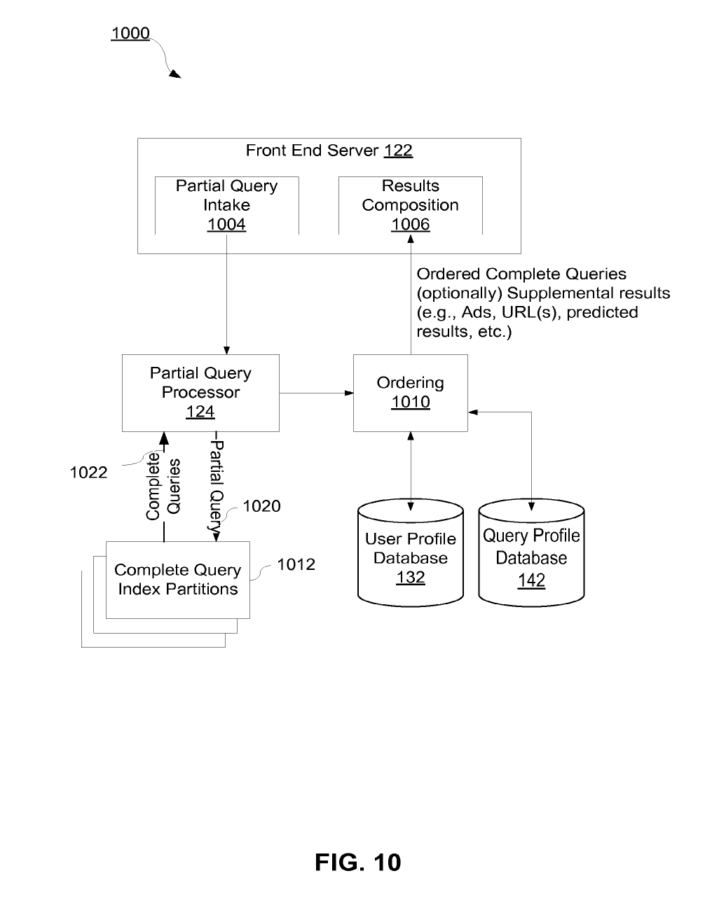

FIG. 10 is a block diagram illustrating an exemplary process 1000 for processing a partial query and ordering the corresponding set of complete queries using the user interest profile and query profiles in accordance with some embodiments. A front end server 122 receives partial queries through a partial query intake interface or process 1004 and sends to the requesting client 104 (FIG. 1) results information. In some implementations the results information includes an ordered set of complete queries. Optionally, the results information includes supplemental results associated with the received partial search query, wherein supplemental results include one or more of the following: one or more advertisements or links to advertisements, one or more URLs, one or more complete queries previously received from the search requestor, supplemental complete queries, (comprising complete queries previously submitted by the community of users, the set of supplemental complete queries ordered in accordance with popularity amongst the community of users), contact information for one or more contacts of the search requestor, and provisional search results.

The received partial search query is processed by a partial search processor 124 to produce a set of complete queries 1022 that match or are otherwise associated with a partial query 1020. In some implementations, partial query processor 124 includes one or more partial query processing modules or processes that control or oversee the searching of a set of complete query index partitions 1012 for complete queries matching the partial query 1020. A set of complete queries are returned 1022 by the partial query processor, and the complete queries in the list are then ordered 1010 according to the user interest profile 348 (FIG. 3C) (from user profile database 132) of the requesting user and the query profiles (from query profile database 142) of the complete queries. Results information, including the ordered complete queries, is forwarded to the results composition module 1006 for conversion into a format (e.g., a web page or XML document) suitable for sending to the requesting client 104 (FIG. 1).

FIG. 11A-11E are flow diagrams illustrating an exemplary process 1100 performed by a server system (e.g., information server system 130, FIG. 1) for personalizing query suggestions provided to a search requestor, in accordance with some embodiments. Optional operations are indicated by dashed lines (e.g., boxes with dashed-line borders).

In accordance with some implementations, a set of complete queries previously submitted by a search requestor is identified 1102. An interest profile 348 (FIG. 3C) of the search requestor is generated 1104 from information that includes the identified set of complete queries previously submitted by the search requestor. The interest profile 348 of the search requestor is determined 1106 based on previous queries, search results, and search result selections recorded for the search requestor. Search results presented to the search requestor are also known as impressions. Search results selected by the search requestor are sometimes called click-throughs.

Optionally, the interest profile of the search requestor is time weighted 1108, with greater weight given to recent events, recent events comprising events that occurred within a predefined number of time units of the current time, than to less recent events. In some implementations the interest profile is time weighted by storing a sequence of interest vectors for a sequence of time periods. The stored vectors are then combined in a time weighted manner.

In some implementations, the set of previously submitted complete queries can be acquired from a variety of sources. If the user is logged in, the set of previously submitted complete queries by a search requestor is obtained from the user profile. If the user is not logged in, the previously submitted complete queries can be obtained by identifying a session ID associated with the received partial search query and obtaining the previously submitted complete queries associated with the identified session ID. For example, the session ID may be stored in a cookie (provided by the server system to the search requestor's computer) that the search requestor's computer returns to the server system with the partial search query. In some implementations, a small number of previously submitted complete queries (e.g., up to five or 10 complete queries submitted during a current session) are stored in a cookie provided by the server system to the search requestor's computer, which the search requestor's computer returns to the server system along with the partial search query. In some implementations, other information used to generate a session profile, to be used in place of or in addition to a user profile, includes one or more of the user's recorded bookmarks selected by the user, toolbar visits by the user, items the user has recommended to others via a social network, and any other online actions performed by the user during the session.

For a respective query in a set of complete queries, the information server system obtains 1110 a classification profile, the classification profile including a list of categories associated with the respective complete query. A partial search query is received 1112 from the search requestor prior to the search requestor signaling completion of a search query that includes the partial search query. The partial search query is received from the search requestor via a client system or device 104 (FIG. 1) distinct from the server system 130 (FIG. 1).

In some implementations, the information server system responds 1114 to receipt of the partial search query by obtaining 1116 a set of complete queries previously submitted by a community of users, the complete queries corresponding to the partial query, the set of complete queries ordered in accordance with (first) ranking criteria. In some implementations, scores are generated 1118 for a plurality of the obtained complete queries previously submitted by the community of users in accordance with interest profile 348 (FIG. 3C) of the search requestor. The obtained complete queries are ordered in accordance with the generated scores and the ranking criteria. In some implementations, for a respective query of the complete queries in the set of complete queries, the interest profile of the search requestor and the classification profile of the respective query are compared 1120.

In some implementations, a distinct classification profile for each complete query in the set of complete queries is obtained 1122 and the interest profile of the search requestor is compared 1122 with the query profile of each respective query in the set of complete queries to generate a respective score for each respective query in the set of complete queries. In some implementations, the score is generated by applying 1124 a matching function to the interest profile of the search requestor and the classification profile of the respective complete query. In some implementations, the score is generated by forming 1126 a dot product of the interest profile of the search requestor and the classification profile of the respective complete query.

In some implementations, other methodologies for ranking complete queries in a set of complete queries are used, either in place of, or in addition to, the methodologies described above. In one example, recent queries by the search requestor are analyzed to determine pairs of terms used together, such as the terms “mountain view” and “restaurants” in the query “mountain view restaurants.” It is noted that a single term can contain two or more words (e.g., examples of single terms include “new york,” “new york city,” “salt lake city” and “federal bureau of investigation”). Stop words are eliminated, weights are applied to the terms, and synonym sets for the terms may also be identified during the analysis. In this context, “synonyms” are terms that are conceptually related, even if they are not truly synonyms, and weights are optionally assigned to synonyms based on a metric of conceptual similarity. When a set of complete queries is obtained for a partial query, the score or ranking of a respective complete query is increased when it “matches” any of the previously determined pairs of terms for the search requestor, where matching includes matching synonyms of or that match any such pairs when one or both of the terms in a respective pair of terms are replaced by synonyms. Thus, if the pairs for the search requestor include the pair (mountain view, restaurants), the complete query “palo alto restaurants” would be considered to be matching because “palo alto” is a weak synonym of “mountain view.” Similarly, the complete query “palo alto dining” would also be considered to be matching, but perhaps with a lower score boost, because “palo alto” is a weak synonym of “mountain view” and “dining” is a synonym of “restaurants.”

The set of ordered complete queries are sent 1128 to the search requestor as suggested complete queries. As noted above, the suggested complete queries sent to the search requestor optionally include additional complete queries, as described next.

In some implementations, user-history complete queries (comprising complete queries previously received from the search requestor) which match the partial search query are identified 1130. For example, the user-history complete queries are obtained by searching query log database 140 (FIGS. 1, 3A) for complete queries previously received from the search requestor which match the partial search query. The identified user-history complete queries are sent 1132 to the search requestor in addition to the set of ordered complete queries.

In some implementations, one or more URLs associated with the partial search query are identified 1134. For example, the entries of the query log database 140 (FIGS. 1, 3A) for the top N suggested complete queries are searched to determine if one or more URLs in the impressions or click-throughs for those suggested complete queries meet predefined criteria. Typically, any URL identified would be very highly ranked in the search results of two or more of the suggested complete queries. In some implementations, these URLs are identified by analyzing click-through statistics on search results produced when a particular suggested complete query is processed, or when a particular partial search query is processed, and identifying only URLs (i.e., the URLs of search results) that were historically selected more than a predefined threshold percentage of the time. These URLs may be called “globally popular URLs.” In some implementations, in addition to or instead of identifying globally popular URLs, the server system attempts to identify one or more personal favorite URLs of the search requestor. In particular, if any of the highly ranked search results for a particular complete query includes a URL having a high click through rate (e.g., above a predefined rate threshold) by the search requestor, that URL is included in the one or more identified URLs. In yet another implementation, a set of globally popular URLs are identified from one or more of the suggested complete queries, possibly with a somewhat lower predefined threshold in order to identify more candidate URLs, those URLs are re-ranked based on the search requestor's interest profile, and then a final threshold requirement is applied to determine if any of the re-ranked URLs qualify for being returned along with the suggested complete queries. The identified URLs, if any, are sent 1136 to the search requestor in addition to the set of ordered complete queries.

Alternatively, or in addition, a plurality of URLs associated with the partial search query are identified 1142. In some implementations, candidate URLs are identified from among the top search results of one or more, or alternatively, two or more, of the suggested complete queries. A score for each respective URL of the plurality of candidate URLs is generated 1144 by comparing the interest profile of the search requestor with a classification profile of the respective URL. One or more URLs of the plurality of URLs are selected 1146 in accordance with the generated scores. The one or more selected URLs are sent 1148 to the search requestor, in addition to the set of ordered complete queries.

In some implementations, contact information for one or more contacts identified in accordance with the partial search query is identified 1138. Optionally, the one or more contacts are identified both in accordance with the partial search query and in accordance with predefined affinity criteria. In one example, from among the contact matching the partial search query, if any, only the contact having the highest affinity with the user is identified. Alternatively, only the N contacts having the highest affinities with the user are identified. Further, in some implementations the predefined affinity criteria include an affinity threshold, such that the identified contacts, if any, only include contacts whose affinity with the user exceeds the affinity threshold. Contact information for the one or more identified contacts is sent 1140 to the search requestor, in addition to the set of ordered complete queries.

In accordance with some implementations, one or more advertisements are identified 1150 in accordance with the partial search query. For example, the one or more advertisements are selected in accordance with one or more of the suggested complete queries, and/or in accordance with the highest ranked search results of one or more of the suggested complete queries, in much the same way that advertisements are selected when the search requestor submitted a complete query to a search engine. Alternatively, or in addition, advertisements can be classified by the interests with which they are associated, and then matching them with the query profiles of the suggested complete queries. Furthermore, recent and/or historical interests of the search requestor are optionally taken into account by blending one or more interest profiles of the search requestor (or of the current session) with the query profile(s) of one or more of the suggested complete queries. The one or more identified advertisements are sent 1152 to the search requestor in addition to the set of ordered complete queries. In some implementations, instead of advertisements, links to advertisements are sent in addition to the set of ordered complete queries.

Alternatively, a plurality of advertisements are identified 1154 in accordance with the partial search query. For each respective advertisement of the plurality of advertisements, a score is generated 1156 by comparing an interest profile of the search requestor with a classification profile of the respective advertisement. One or more advertisements of the plurality of advertisements are selected 1160 in accordance with the generated scores. The selected one or more advertisements are sent 1160 to the search requestor, in addition to the set of ordered complete queries.

Supplemental complete queries (comprising complete queries previously submitted by the community of users) are identified 1162, the supplemental complete queries corresponding to the partial query. Typically, the supplemental complete queries are selected so as to exclude the primary suggested complete queries obtained at 1116. The set of supplemental complete queries are ordered in accordance with second ranking criteria distinct from the first ranking criteria. The second criteria comprise 1164 popularity criteria with respect to the community of users. In one example, the supplemental complete queries matching the partial search query, if any, are ordered in accordance with the query popularity 328 values in the query profiles of the supplemental complete queries. Optionally, identifying the supplemental complete queries includes identifying a predefined number of most popular complete queries that match the partial query. In another example, the total number of primary complete queries, user-history complete queries and supplemental complete queries is limited to a maximum number, such as 6, 8 or 10, and the number of supplemental complete queries identified at 1162 is restricted in accordance with that maximum number.

The identified supplemental complete queries are sent 1166 to the search requestor in addition to the set of ordered complete queries and any user-history complete queries identified at 1130.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, performed by a server system having one or more processors and memory storing one or more programs for execution by the one or more processors, the method comprising:
at the server system:
receiving from a search requestor a partial search query; the receiving including receiving the partial search query from the search requestor prior to the search requestor signaling completion of a search query that includes the partial search query; wherein the partial search query is received from the search requestor via a client system or device distinct from the server system;
responding to receipt of the partial search query by:
obtaining a set of complete queries previously submitted by a community of users, the complete queries corresponding to the partial query, the set of complete queries ordered in accordance with ranking criteria; and
sending at least a subset of the set of ordered complete queries to the search requestor as suggested complete queries;
the obtaining including generating scores for a plurality of the obtained complete queries previously submitted by the community of users in accordance with an interest profile of the search requestor and ordering the obtained complete queries in accordance with the generated scores and the ranking criteria.

2. The method of claim 1,
prior to receiving the partial search query:
identifying a set of complete queries previously submitted by the search requestor; and
generating the interest profile of the search requestor from information that includes the identified set of complete queries previously submitted by the search requestor.

3. The method of claim 1, wherein the interest profile of the search requestor is determined based on previous queries, search results and search result selections recorded for the search requestor.

4. The method of claim 1, wherein the interest profile is time weighted, with greater weight given to recent events, recent events comprising events that occurred within a predefined number of time units of the current time, than to less recent events

5. The method of claim 1, including obtaining, for a respective query of the complete queries in the set of complete queries, a classification profile, the classification profile including a list of categories associated with the respective complete query.

6. The method of claim 5, wherein generating the score for the respective query comprises comparing the interest profile of the search requestor with the classification profile of the respective query.

7. The method of claim 6, including obtaining a distinct classification profile for each complete query in the set of complete queries and comparing the interest profile of the search requestor with the classification profile of each respective query in the set of complete queries to generate a respective score for each respective query in the set of complete queries.

8. The method of claim 6 wherein generating the score comprises applying a matching function to the interest profile of the search requestor and the classification profile of the respective complete query.

9. The method of claim 6 wherein generating the score comprises forming a dot product of the interest profile of the search requestor and the classification profile of the respective complete query.

10. The method of claim 1, further comprising responding to receipt of the partial search query by:
identifying user-history complete queries, comprising complete queries previously received from the search requestor which match the partial search query; and
sending to the search requestor, in addition to suggested complete queries, the identified user-history complete queries.

11. The method of claim 1, further comprising responding to receipt of the partial search query by:
identifying a URL associated with the partial search query; and
sending to the search requestor, in addition to the suggested complete queries, the identified URL.

12. The method of claim 1, further comprising responding to receipt of the partial search query by:
identifying a plurality of URLs associated with the partial search query;
generating a score for each respective URL of the plurality of URLs by comparing an interest profile of the search requestor with a classification profile of the respective URL;
selecting one or more URLs of the plurality of URLs in accordance with the generated scores; and
sending to the search requestor, in addition to the suggested complete queries, the selected one or more URLs.

13. The method of claim 1, further comprising responding to receipt of the partial search query by:
identifying at least one advertisement identified in accordance with the partial search query; and
sending to the search requestor, in addition to the suggested complete queries, the at least one identified advertisement.

14. The method of claim 1, further comprising responding to receipt of the partial search query by:
identifying a plurality of advertisements in accordance with the partial search query;
generating a score for each respective advertisement of the plurality of advertisements by comparing an interest profile of the search requestor with a classification profile of the respective advertisement;
selecting one or more advertisements of the plurality of advertisements in accordance with the generated scores; and
sending to the search requestor, in addition to the suggested complete queries, the selected one or more advertisements.

15. The method of claim 1, wherein the ranking criteria comprise first ranking criteria;
further comprising responding to receipt of the partial search query by:
identifying supplemental complete queries, comprising complete queries previously submitted by the community of users, the supplemental complete queries corresponding to the partial query, the set of supplemental complete queries ordered in accordance with second ranking criteria distinct from the first ranking criteria; and
sending to the search requestor, in addition to the suggested complete queries, the identified supplemental complete queries.

16. The method of claim 15, wherein the second ranking criteria comprise popularity criteria with respect to the community of users, and wherein identifying the supplemental complete queries includes identifying a predefined number of most popular complete queries that match the partial query.

17. The method of claim 1, further comprising responding to receipt of the partial search query by:
identifying contact information for one or more contacts identified in accordance with the partial search query; and
sending to the search requestor, in addition to the suggested complete queries, the contact information for the one or more identified contacts.

18. A server system, comprising:
one or more processors; and
memory storing one or more programs for execution by the one or more processors, the one or more programs including instructions for:
receiving from a search requestor a partial search query; the receiving including receiving the partial search query from the search requestor prior to the search requestor signaling completion of a search query that includes the partial search query; wherein the partial search query is received from the search requestor via a client system or device distinct from the server system;
responding to receipt of the partial search query by:
obtaining a set of complete queries previously submitted by a community of users, the complete queries corresponding to the partial query, the set of complete queries ordered in accordance with ranking criteria; and
sending at least a subset of the set of ordered complete queries to the search requestor as suggested complete queries;
the obtaining including generating scores for a plurality of the obtained complete queries previously submitted by the community of users in accordance with an interest profile of the search requestor and ordering the obtained complete queries in accordance with the generated scores and the ranking criteria.

19. The server system of claim 18, wherein the one or more programs further include instructions for:
prior to receiving the partial search query:
identifying a set of complete queries previously submitted by the search requestor; and
generating the interest profile of the search requestor from information that includes the identified set of complete queries previously submitted by the search requestor.

20. The server system of claim 18, wherein the interest profile of the search requestor is determined based on previous queries, search results and search result selections recorded for the search requestor.

21. A non-transitory computer readable storage medium, storing one or more programs for execution by one or more processors of a server system, the one or more programs including instructions for:
receiving from a search requestor a partial search query; the receiving including receiving the partial search query from the search requestor prior to the search requestor signaling completion of a search query that includes the partial search query; wherein the partial search query is received from the search requestor via a client system or device distinct from the server system;
responding to receipt of the partial search query by:
obtaining a set of complete queries previously submitted by a community of users, the complete queries corresponding to the partial query, the set of complete queries ordered in accordance with ranking criteria; and
sending at least a subset of the set of ordered complete queries to the search requestor as suggested complete queries;
the obtaining including generating scores for a plurality of the obtained complete queries previously submitted by the community of users in accordance with an interest profile of the search requestor and ordering the obtained complete queries in accordance with the generated scores and the ranking criteria.

22. The non-transitory computer readable storage medium of claim 21, wherein the one or more programs further include instructions for:
prior to receiving the partial search query:
identifying a set of complete queries previously submitted by the search requestor; and
generating the interest profile of the search requestor from information that includes the identified set of complete queries previously submitted by the search requestor.

23. The non-transitory computer readable storage medium of claim 21, wherein the interest profile of the search requestor is determined based on previous queries, search results and search result selections recorded for the search requestor.
